(19) United States
(12) Patent Application Publication
(10) Pub. No.: US 2022/0320363 A1
(43) Pub. Date: Oct. 6, 2022

(54) THREE-AXIS RIBBON CUTTER AND IMPLEMENTATION METHOD THEREOF

(71) Applicant: HANGZHOU JOY ENERGY TECHNOLOGY CO., LTD., Hangzhou (CN)

(72) Inventors: Jiandang ZHANG, Hangzhou (CN); Zhiyu ZHANG, Hangzhou (CN)

(73) Assignee: HANGZHOU JOY ENERGY TECHNOLOGY CO., LTD., Hangzhou (CN)

(21) Appl. No.: 17/657,419

(22) Filed: Mar. 31, 2022

(30) Foreign Application Priority Data
Apr. 6, 2021 (CN) 202110368547.7

(51) Int. Cl. H01L 31/18

(52) U.S. Cl. CPC H01L 31/188

(57) ABSTRACT

A three-axial ribbon cutter and an implementation method thereof are disclosed, which relates to a technical field of ribbon cutting. The cutter includes a base, a traversing cutter set, a ribbon guiding mechanism, a first guide rail, a second guide rail, a cutting cylinder, a lifting cylinder, a traversing cylinder and a ribbon. An mounting block is provided on the base, the mounting block is connected with the traversing cutter set, the ribbon guiding mechanism, the first guide rail, the cutting cylinder, the lifting cylinder and the traversing cylinder; cutters of the traversing cutter set and the ribbon guiding mechanism are provided in multiple sets; the traversing cutter set includes special-shaped cutters which are connected to the cutting cylinder and the traversing cylinder, edges of the special-shaped cutters extend by a certain volume, and the traversing cutter set and the lower cutter are both connected to the lifting cylinder.

### CROSS-REFERENCE TO RELATED APPLICATIONS

This Non-provisional application claims priority under 35 U.S.C. § 119(a) to Chinese Patent Application No. 202110368547.7, filed on 6 Apr. 2021, the entire contents of which are hereby incorporated by reference in its entirety.

### TECHNICAL FIELD

The disclosure relates to a technical field of ribbon cutting, in particular to a three-axial ribbon cutter and an implementation method thereof.

### BACKGROUND ART

PV ribbons, also known as tin-plated copper tape or tin-coated copper tape, are divided into bus bars and interconnection bars, which are applied to connection between solar cells of a PV module and play important roles in conducting and collecting electricity. A ribbon is an important raw material in a welding process of the PV module, and quality of ribbon will directly affect current collection efficiency of the PV module and greatly influence power of the PV module. However, due to physical characteristics of the ribbon, its cutting process has certain technical requirements.

Traditional cutting of the ribbon is usually made with an upper cutter combined with a lower cutter, but the upper cutter is too bulky, a design of multi-set ribbon handling structure is not easy to realize on this structure; a width of the upper cutter is excessively large and occupies a large part of space, which does not facilitate handling scheduling; and cutting and drawing for multiple sets of ribbons cannot be carried out.

### SUMMARY

### 1. Problems to be Solved

In view of the above problem in traditional ribbon cutting that a design of multi-set ribbon handling structure is not easy to realize on that structure, a width of the upper cutter is excessively large and occupies a large part of space, which does not facilitate handling scheduling, and cutting and drawing for multiple sets of ribbons cannot be carried out, a three-axial ribbon cutter and an implementation method thereof are provided in this disclosure, in which a cutting cylinder, a lifting cylinder and a traversing cylinder are designed to cooperate with multiple sets of special-shaped cutters and a lower cutter, so that the cutters can be moved in three axes, realizing automatic multi-set cutting, thus greatly improving cutting efficiency, protecting the ribbon, improving cutting effect and presenting high safety.

### 2. Solution

To solve the above problems, the technical scheme provided in the disclosure is as follows:

A three-axis ribbon cutter includes a base, a traversing cutter set, a ribbon guiding mechanism, a first guide rail, a second guide rail, a cutting cylinder, a lifting cylinder, a traversing cylinder and a ribbon. An mounting block is provided on the base, the mounting block is connected with the traversing cutter set, the ribbon guiding mechanism, the first guide rail, the second guide rail, the cutting cylinder, the lifting cylinder and the traversing cylinder; cutters of the traversing cutter set and the ribbon guiding mechanism are provided in multiple sets; the traversing cutter set includes special-shaped cutters which are connected to the cutting cylinder and the traversing cylinder, edges of the special-shaped cutters extend by a certain volume, and the traversing cutter set and the lower cutter are both connected to the lifting cylinder. Under actions of the cutting cylinder and the traversing cylinder, the traversing cutter set can traverse along its own cutter arranging direction and perform cutting actions. Lifting actions of the traversing cutter set and the lower cutter are carried out under control of the lifting cylinder, and in order to raise the cutters to a preset ribbon height, the cutters are previously lower than this height to make space available for the ribbon to be pulled into this device.

Optionally, the traversing cutter set and the lower cutter are slidably connected to the mounting block through the first guide rail; and the second guide rail is slidably connected to a bottom of the base. The whole device can slide and translate under an action of the second guide rail. The first guide rail serves as a structure for lifting.

Optionally, edges of the special-shaped cutters are wider than shanks of the special-shaped cutters. After the ribbon is pulled in place, the special-shaped cutters will be raised to the cutting height, and the ribbon will block a rising path. A similar gap is left in shanks of the special-shaped cutters. When the special-shaped cutter rises, it bypasses the ribbon through the traversing cylinder, and when it reaches the height, the gap can be buckled above the ribbon, and when cutting is to be made, it will fall to finish the cutting.

Optionally, edges of the special-shaped cutter and the lower cutter are staggered, the cutters are trapezoidal in shape, and angles of the edges are 50-90 degrees. Instead of a traditional sharp edge, a trapezoidal edge can provide a certain supporting force when the ribbon is cut, while the ribbon is bent when it is cut, and the trapezoidal edge can protect the ribbon from being bent after cutting. Service life of the cutter is prolonged, and the cutter is not easy to become dull.

Optionally, the ribbon guiding mechanism is provided with through holes matched with a number of the special-shaped cutters. The through holes are configured to pass through a primary limit ribbon.

Optionally, driving directions of the cutting cylinder and the lifting cylinder are perpendicular to directions of the ribbon and the cutters; and a driving direction of the traversing cylinder is the same as an arrangement direction of the traversing cutter set.

Optionally, the special-shaped cutters and the lower cutter are integrally formed. An integrally formed structure is beneficial to improve a structural strength of the special-shaped cutters and the lower cutter.

Optionally, the mounting block is connected with the first guide rail through a bolt structure.

The implementation method of the three-axis ribbon cutter includes the following steps.

1. A ribbon pulling mechanism pulls the ribbon to the ribbon guiding mechanism, and the lifting cylinder is in a low position to leave space for the ribbon pulling mechanism;

2. The lifting cylinder lifts the traversing cutter set and the lower cutter to make an edge of the lower cutter flush with the ribbon, and then the transverse cylinder moves to make edges of the special-shaped cutters bypass the ribbon and reach directly above the ribbon, and then cut the ribbon.

3. After the cutting is finished, the special-shaped cutters rise and the transverse cylinder retracts, and then the lifting cylinder lowers to a low position to prepare for a next cutting.

Optionally, the ribbon pulling mechanism is an external tooling structure used to straighten the ribbon and pull it to a preset cutting position of the ribbon guiding mechanism.

### 3. Beneficial Effects

Compared with the prior art, the technical schemes provided in the disclosure have the following beneficial effects:

(1) The three-axis ribbon cutter and its implementation method proposed in the embodiment of this disclosure improve cutting efficiency of the ribbon.

(2) The three-axial ribbon cutter and its implementation method proposed in the embodiment of this disclosure have good cutting effect of the ribbon.

(3) The three-axial ribbon cutter and its implementation method proposed in the embodiment of this disclosure facilitates ribbon cutting.

(4) In the three-axial ribbon cutter and its implementation method proposed in the embodiment of this disclosure, the cutter is in a low position when it is not in operation, which is far away from the operator and has high safety.

### BRIEF DESCRIPTION OF THE DRAWINGS

FIG. 1 is a schematic structural diagram of a three-axial ribbon cutter according to an embodiment of the present disclosure.

FIG. 2 is a front view of a three-axial ribbon cutter according to an embodiment of the present disclosure.

FIG. 3 is a right view of the three-axial ribbon cutter according to the embodiment of the present disclosure.

FIG. 4 is a schematic diagram of an implementation method of the three-axial ribbon cutter according to an embodiment of the present disclosure.

1. Base; 2. Traversing Cutter Set; 21. Special-shaped Cutters; 22. Lower Cutter; 3. Ribbon Guiding Mechanism; 4. First Guide Rail; 5. Second Guide Rail; 6. Cutting Cylinder; 7. Lift Cylinder; 8. Traversing Cylinder; 9. Ribbon.

### DETAILED DESCRIPTION

In order to further understand contents of the present disclosure, the present disclosure will be described in detail with reference to drawings and examples.

The application will be further described in detail with reference to the drawings and embodiments. It can be understood that the specific embodiments described herein are only intended to explain related disclosures, but not to limit the disclosure. In addition, it should also be noted that for convenience of description, only the parts related to the disclosure are shown in the drawings. Terms such as “first” and “second” mentioned in the present disclosure are provided for the convenience of describing the technical scheme of the present disclosure, have no specific limiting function, are all general terms and do not constitute a limiting for the technical scheme of the present disclosure. It should be noted that the embodiments in the present application and the characteristics in the embodiments can be combined mutually in the case of no conflict. In the description of the present disclosure, it should be understood that the terms “center”, “upper”, “lower”, “left”, “right”, “vertical”, “horizontal”, “inner” and “outer” which indicate an orientation or positional relationship are based on the orientation or positional relationship shown in the drawings, and are merely for convenience of describing the present disclosure and simplifying the description, rather than indicate or imply that the device or element referred to must have a specific orientation, be configured and operated in a specific orientation, and thus cannot be understood as a limitation on the present disclosure. In addition, the terms “first”, “second” and “third” are only configured for descriptive purposes and cannot be understood as indicating or implying a relative importance. Unless otherwise specified and limited, the terms “installing”, “coupling” and “connecting” should be understood in a broad sense, for example, it can be “fixedly connecting”, or “detachably connecting” or “integrally connecting”, or it can be “mechanically connecting” or “electrically connecting”, or it can be “directly connecting” or “indirectly connecting through an intermediate medium”, or it can be “communicating within two elements”. For a person of ordinary skill in the art, specific meanings of the above terms in the present disclosure can be understood according to specific situations. A plurality of technical solutions in a same embodiment as well as a plurality of technical solutions in different embodiments can be arranged and combined to form a new technical solution without contradictions or conflicts, all of which are within a claimed scope of the present disclosure.

### Embodiments

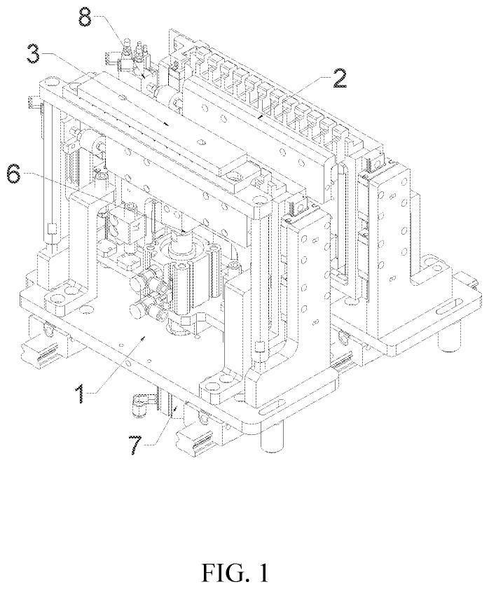

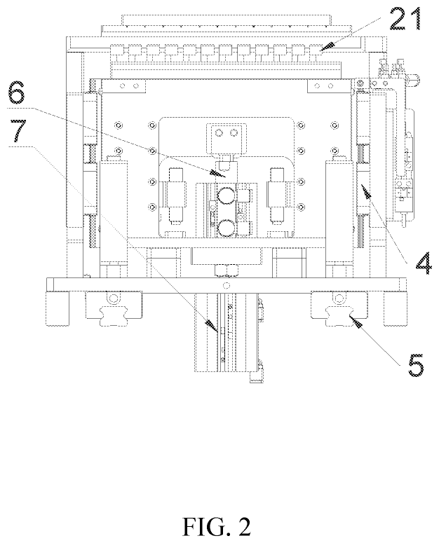

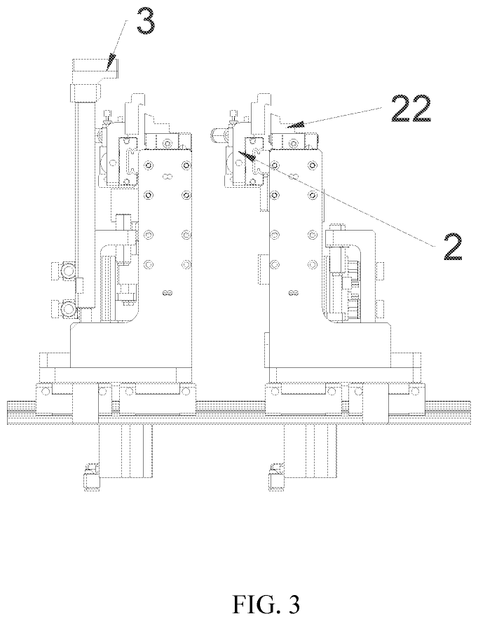

With reference to FIGS. 1-4, the three-axis ribbon cutter includes a base 1, a traversing cutter set 2, a ribbon guiding mechanism 3, a first guide rail 4, a second guide rail 5, a cutting cylinder 6, a lifting cylinder 7, a traversing cylinder 8 and a ribbon 9. A mounting block is provided on the base 1 and the mounting block is connected with the first guide rail through a bolt structure or a rivet structure.

The mounting block is connected with the traversing cutter set 2, the ribbon guiding mechanism 3, the first guide rail 4, the second guide rail 5, the cutting cylinder 6, the lifting cylinder 7 and the traversing cylinder 8; cutters of the traversing cutter set 2 and the ribbon guiding mechanism 3 are provided in multiple sets, and the ribbon guiding mechanism 3 is provided with through holes matched with a number of special-shaped cutters 21. The through holes are configured to pass through a primary limit ribbon 9.

The traversing cutter set 2 includes special-shaped cutters 21 which are connected to the cutting cylinder 6 and the traversing cylinder 8, edges of the special-shaped cutters extend by a certain volume, and edges of the special-shaped cutters 21 are wider than shanks of the special-shaped cutters. After the ribbon 9 is pulled in place, the special-shaped cutters 21 will be raised to the cutting height, and the ribbon 9 will block a rising path. A similar gap is left in shanks of the special-shaped cutters 21. When the special-shaped cutter rises, it bypasses the ribbon 9 through the traversing cylinder 8, and when it reaches the height, the gap can be buckled above the ribbon 9, and when cutting is to be made, it will fall to finish the cutting.

The traversing cutter set 2 and the lower cutter 22 are both connected to the lifting cylinder 7. The traversing cutter set 2 and the lower cutter 22 are slidably connected to the mounting block through the first guide rail 4; and the second guide rail 5 is slidably connected to a bottom of the base 1. The whole device can slide and translate under an action of the second guide rail 5. The first guide rail 4 serves as a structure for lifting. Under actions of the cutting cylinder 6 and the traversing cylinder 8, the traversing cutter set 2 can traverse along its own cutter arranging direction and perform cutting actions. Lifting actions of the traversing cutter set 2 and the lower cutter 22 are carried out under control of the lifting cylinder 7, and in order to raise the cutters to a preset ribbon 9 height, the cutters are previously lower than this height to make space available for the ribbon 9 to be pulled into this device.

Edges of the special-shaped cutter 21 and the lower cutter 22 are staggered, the cutters are trapezoidal in shape, and angles of the edges are 50-90 degrees. Instead of a traditional sharp edge, a trapezoidal edge can provide a certain supporting force when the ribbon 9 is cut, while the ribbon 9 is bent when it is cut, and the trapezoidal edge can protect the ribbon 9 from being bent after cutting. Service life of the cutter is prolonged, and the cutter is not easy to become dull. The special-shaped cutters 21 and the lower cutter 22 are integrally formed. An integrally formed structure is beneficial to improve a structural strength of the special-shaped cutters 21 and the lower cutter 22.

Driving directions of the cutting cylinder 6 and the lifting cylinder 7 are perpendicular to directions of the ribbon 9 and the cutters; and a driving direction of the traversing cylinder 8 is the same as an arrangement direction of the traversing cutter set 2.

The implementation method includes following steps:

1. A ribbon 9 pulling mechanism pulls the ribbon 9, and the cutter lifting cylinder 7 is in a low position to leave space for the ribbon 9 pulling mechanism. When the cutters at a ribbon-taking position, the cutters are at a height lower than a height of the ribbon 9, and at this time, the ribbon 9 pulling mechanism can pass tops of the cutters and pull the ribbon 9. One of advantages of this design is that space above the cutters can be opened to make room for an action of the ribbon 9 pulling mechanism, and at the same time, the open space also creates favorable conditions for multi-set handling of the ribbon 9.

2. The lifting cylinder 7 rises to make a cutting edge of the lower cutter 22 flush with the ribbon 9, and then the transverse cylinder 8 moves to make edges of the special-shaped cutters be located directly above the ribbon 9, and then cut the ribbon 9. In an arrangement of the cutters, we combine multiple sets of cutters. An advantage of the multiple sets of cutters is that they can make cutting for multiple segments of ribbons 9 at the same time, which greatly improves cutting efficiency of the ribbon 9 and creates favorable conditions for productivity improvement of a string welder.

3. After the cutting is finished, the special-shaped cutters rise and the transverse cylinder 8 retracts, and then the lifting cylinder 7 lowers to a low position to prepare for a next cutting.

Edges of the special-shaped cutters and only span 5-7 mm between opening and closing, and when the cutters are not in operation, they are in a low position and far away from the operator, which has a certain protective effect on safety of an operator threading the ribbon and has high safety.

The ribbon 9 pulling mechanism is an external tooling structure used to straighten the ribbon 9 and pull it to a preset cutting position of the ribbon guiding mechanism.

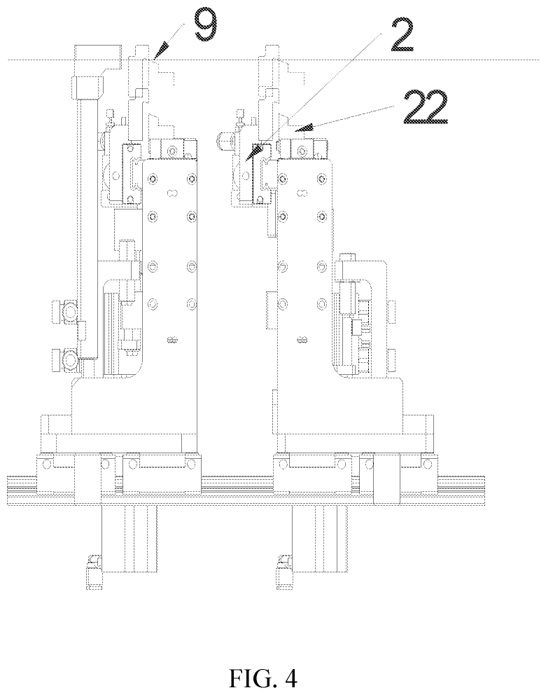

As shown in FIG. 4, a dotted-line part is at a high position of the lifting cylinder 7, where the special-shaped cutters 21 and the lower cutter 22 are located when the cutting is made.

The present disclosure and embodiments thereof are described above in an illustrative manner, which is not restrictive; and what is shown in the drawings is only one of the embodiments of the present disclosure, and its actual structure is not limited thereto. Therefore, structures and embodiments similar to the technical scheme designed by those of ordinary skilled in the art inspired by this disclosure without creativity, without departing from the creative purpose of the present disclosure, are all within a protection scope of the present disclosure.

What is claimed is:

1. A three-axis ribbon cutter, comprising:
a base;
a traversing cutter set;
a ribbon guiding mechanism;
a first guide rail;
a second guide rail;
a cutting cylinder;
a lifting cylinder;
a traversing cylinder; and
a ribbon,
wherein a mounting block is provided on the base, the mounting block is connected with the traversing cutter set, the ribbon guiding mechanism, the first guide rail, the cutting cylinder, the lifting cylinder and the traversing cylinder; the traversing cutter set comprises special-shaped cutters, the ribbon guiding mechanism is provided with through holes, the special-shaped cutters and the through holes are provided in multiple sets; the special-shaped cutters are connected to the cutting cylinder and the traversing cylinder, edges of the special-shaped cutters extend by a certain volume, edges of the special-shaped cutters are wider than shanks of the special-shaped cutters, edges of the special-shaped cutters and a lower cutter are staggered, and the traversing cutter set and the lower cutter are both connected to the lifting cylinder.

2. The three-axis ribbon cutter according to claim 1, wherein the traversing cutter set and the lower cutter are slidably connected to the mounting block through the first guide rail; and the second guide rail is slidably connected to a bottom of the base.

3. The three-axial ribbon cutter according to claim 1, wherein the cutters of the special-shaped cutters and the lower cutter both are trapezoidal in shape, and angles of the edges are 50-90 degrees.

4. The three-axial ribbon cutter according to claim 1, wherein a number of through holes matched with a number of the special-shaped cutters.

5. The three-axial ribbon cutter according to claim 1, wherein driving directions of the cutting cylinder and the lifting cylinder are perpendicular to arrangement directions of the ribbon and the traversing cutter set; and a driving direction of the traversing cylinder is the same as an arrangement direction of the traversing cutter set.

6. The three-axial ribbon cutter according to claim 1, wherein the special-shaped cutters and the lower cutter are integrally formed.

7. The three-axial ribbon cutter according to claim 1, wherein the mounting block is connected with the first guide rail through a bolt structure.

8. An implementation method of the three-axial ribbon cutter according to claim 1, wherein the method comprises the following steps:
pulling, by a ribbon pulling mechanism, the ribbon to the ribbon guiding mechanism, with the lifting cylinder being in a low position to leave space for the ribbon pulling mechanism;
lifting, by the lifting cylinder, the traversing cutter set and the lower cutter to make an edge of the lower cutter flush with the ribbon, and then moving the transverse cylinder to make edges of the special-shaped cutters bypass the ribbon and reach directly above the ribbon, and then cut the ribbon; and
raising the special-shaped cutters and retracting the transverse cylinder after a cutting is finished, and then lowering the lifting cylinder to the low position to prepare for a next cutting.

9. The implementation method of the three-axial ribbon cutter according to claim 9, wherein the ribbon pulling mechanism is an external tooling structure used to straighten the ribbon and pull it to a preset cutting position of the ribbon guiding mechanism.

10. The three-axial ribbon cutter according to claim 2, wherein the special-shaped cutters and the lower cutter are integrally formed.

11. The three-axial ribbon cutter according to claim 3, wherein the special-shaped cutters and the lower cutter are integrally formed.

12. The three-axial ribbon cutter according to claim 4, wherein the special-shaped cutters and the lower cutter are integrally formed.

13. The three-axial ribbon cutter according to claim 5, wherein the special-shaped cutters and the lower cutter are integrally formed.

14. The three-axial ribbon cutter according to claim 2, wherein the mounting block is connected with the first guide rail through a bolt structure.

15. The three-axial ribbon cutter according to claim 3, wherein the mounting block is connected with the first guide rail through a bolt structure.

16. The three-axial ribbon cutter according to claim 4 wherein the mounting block is connected with the first guide rail through a bolt structure.

17. The three-axial ribbon cutter according to claim 5, wherein the mounting block is connected with the first guide rail through a bolt structure.

18. The three-axial ribbon cutter according to claim 6, wherein the mounting block is connected with the first guide rail through a bolt structure.
